(19) United States
(12) Patent Application Publication
(10) Pub. No.: US 2024/0141526 A1
(43) Pub. Date: May 2, 2024

(54) BROMINE AND LITHIUM EXTRACTION FROM AQUEOUS SOURCES

(71) Applicant: Schlumberger Technology Corporation, Sugar Land, TX (US)

(72) Inventors: Dominic Vincent Perroni, Sugar Land, TX (US); Florence Binet, Houston, TX (US)

(21) Appl. No.: 18/498,842

(22) Filed: Oct. 31, 2023

Related U.S. Application Data
(60) Provisional application No. 63/381,611, filed on Oct. 31, 2022.
(60) Provisional application No. 63/386,356, filed on Dec. 7, 2022.

(30) Foreign Application Priority Data
Aug. 23, 2023 (WO) PCT/US2023/030928
Aug. 23, 2023 (WO) PCT/US2023/030949

(51) Int. Cl. C25B 15/08; C01B 7/09; C25B 1/16; C25B 1/26

(52) U.S. Cl. CPC C25B 15/081; C01B 7/096; C25B 1/16; C25B 1/26

(57) ABSTRACT

Methods comprise generating chlorine gas in a conversion process that converts metal chloride from an aqueous medium derived from a metal containing aqueous source into a hydroxide material; recovering the chlorine gas; and recovering bromine by reacting the chlorine gas with a bromide containing aqueous source. The methods and apparatus described herein also provide for removing sulfide species and/or organic species and/or transition metals, among others. The methods may be applicable for instance to lithium conversion and may be coupled to a direct extraction process for lithium extraction.

### CROSS-REFERENCE TO RELATED APPLICATIONS

This patent application claims benefit of U.S. Provisional Patent Application No. 63/381,611, filed Oct. 31, 2022, and of U.S. Provisional Patent Application No. 63/386,356, filed Dec. 7, 2022, and of PCT applications PCT/US2023/030928 and PCT/US2023/030949 filed on Aug. 23, 2023 each of which is entirely incorporated herein by reference.

### FIELD

This patent application relates to recovering metal ions, such as lithium, from an aqueous source, such as brine. Specifically, this patent application describes processes for direct aqueous extraction of ions that use methods of removing hydrocarbon and/or sulfide species, and also recovering bromine.

### BACKGROUND

Lithium is a key element in energy storage. Electrical storage devices, such as batteries, supercapacitors, and other devices commonly use lithium to mediate the storage and release of chemical potential energy as electrical current. As demand for renewable, but non-transportable, energy sources such as solar and wind energy grows, demand for technologies to store energy generated using such sources also grows.

According to the United States Geological Survey, global reserves of lithium total 22 million tons (metric) of lithium content, with Chile, Australia, Argentina, and China accounting for about 85% of global reserves. U.S. Geological Survey, Mineral Commodity Summaries, January 2022. According to S&P Global Market Intelligence, lithium supply is forecast to be 636 kT LCE in 2022, up from 497 kT in 2021. Global consumption was estimated at 64 kT in 2021, putting current lithium supplies in deficit. Global consumption and is expected to reach 2 MTa by 2030 for an average annual growth in demand of approximately 13.5%. Supply is currently forecast to run behind demand, and lithium prices currently outstrip even the most optimistic forecasts. While lithium prices are quite volatile as the global market develops, lithium prices are expected to remain high through 2030. The incentive for more lithium production could not be clearer.

In fact, a number of ions can be sourced from aqueous materials present at or near the surface of the earth. Ions such as lithium, manganese, nickel, cobalt, and others can be extracted using direct aqueous extraction. Aqueous materials subjected to such extraction can have different compositions that include various critical ions, as well as different contaminants. Some aqueous materials, for instance brines from the Smackover field and brine that has undergone prior bromine production, may include sulfides and/or hydrocarbons/organics, which are typically undesirable for efficient extraction using direct aqueous processes.

Bromine is a halogen element that is used mostly to manufacture flame retardant chemicals. The market for bromine is forecast, by one estimate, to grow at more than 4% per year over the next five years. Efficient and effective ways of recovering lithium and bromine, and removing impurities such as sulfides and organic compounds, are needed.

### SUMMARY

Embodiments described herein provide a method, comprising generating chlorine gas in a conversion process that converts metal chloride from an aqueous medium obtained from a metal containing aqueous source into a hydroxide material; recovering the chlorine gas; and recovering bromine by reacting the chlorine gas with a bromide containing aqueous source.

Other embodiments described herein provide method, comprising withdrawing lithium ions from an aqueous medium comprising lithium ions using a direct extraction process to form an aqueous lithium extract; converting lithium ions of a stream derived from the lithium extract to lithium hydroxide using an electrochemical process; converting chloride ions of the stream derived from the lithium extract to chlorine gas using the electrochemical process; and reacting the chlorine gas with an aqueous source comprising bromide ions to form bromine gas from the bromide ions.

Other embodiments described herein provide a method, comprising reducing a concentration of at least one or more of sulfide species, transition metal ions, organic species, from an aqueous source comprising lithium ions and bromide ions; reacting a stream derived from the aqueous source with a chlorine gas stream to form bromine and a bromide depleted aqueous stream; extracting lithium ions from the stream resulting from removing organic species from the bromide depleted aqueous stream, using a direct extraction process, to form a lithium extract; and converting lithium of the lithium extract to lithium hydroxide in an electrochemical process that uses a lithium selective barrier to form the chlorine gas stream.

Other embodiment described herein provide a method of recovering lithium and bromine, comprising reducing a concentration of at least one or more of sulfide species, transition metal ions, organic species, from an aqueous source comprising lithium ions and bromide ions to form a purified aqueous source; extracting lithium ions from a stream derived from the purified aqueous using a direct extraction process to form a lithium depleted stream comprising bromide ions and a lithium extract comprising lithium ions; converting lithium of the lithium extract to lithium hydroxide in an electrochemical process that uses a lithium selective barrier to form a chlorine gas stream; and reacting the lithium depleted stream with the chlorine gas stream to form bromine and a bromide depleted aqueous stream.

### BRIEF DESCRIPTION OF THE DRAWINGS

FIG. 1 is a schematic process diagram of a lithium and bromine recovery process according to one embodiment.

FIG. 2 is a schematic process diagram of a process for removing hydrocarbons and/or other organic species from an aqueous stream, according to one embodiment.

FIG. 3 is a schematic process diagram summarizing a method according to another embodiment.

FIG. 4 is a schematic process diagram of an ion recovery process according to another embodiment.

### DETAILED DESCRIPTION

Lithium can be recovered from an aqueous source bearing lithium ions by extraction and concentration methods. Most such aqueous streams also contain chloride ions and bromide ions. Extraction methods generally yield an aqueous stream with increased concentration of lithium ions and chloride ions by selectively withdrawing lithium ions from the aqueous source and re-dissolving them in an aqueous stream at a selected concentration. Concentration methods remove water, potentially with other species, to yield higher concentration of lithium and chloride ions.

Concentrated lithium bearing aqueous streams can be subjected to a membrane electrochemical process to convert lithium to lithium hydroxide, generating chlorine gas from the chloride ions in the aqueous stream. The chlorine gas can be contacted with the aqueous source to recover bromine from the aqueous source. Additionally, the chlorine gas can be contacted with the aqueous source to remove sulfide species from the aqueous source.

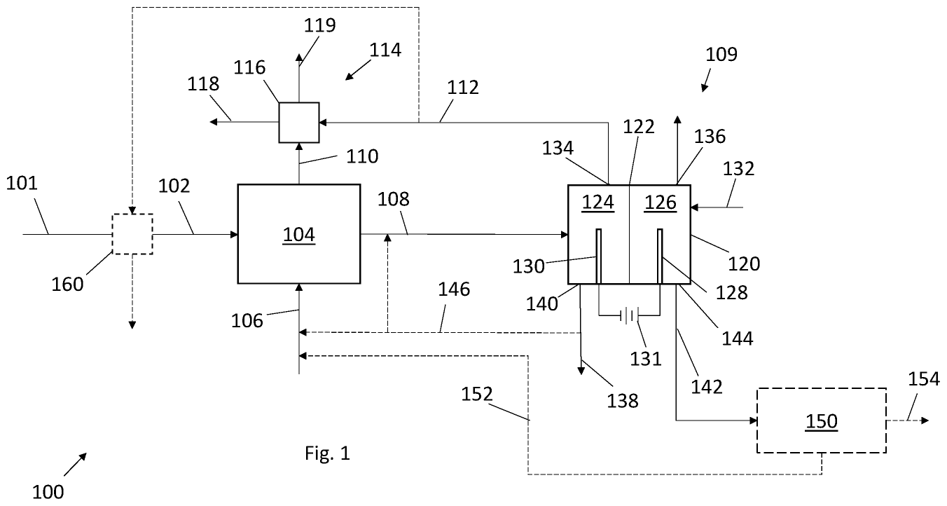

FIG. 1 is a schematic process diagram of a lithium and bromine recovery process 100 according to one embodiment. An aqueous source 102 that contains lithium ions, chloride ions, and bromide ions is routed to an extraction stage 104 where lithium is extracted by a withdrawal process. The aqueous source 102 is contacted with a lithium selective medium, which may be solid or liquid or semi-solid fluid or gel. An example of such medium for lithium ions is a Lithium Aluminum Intercalate (LAI) sorbent but any known medium for removing a specific target ion may be used. The lithium selective medium withdraws lithium ions, with or without withdrawing anions, such as chloride ions or other anions, depending on the medium, from the aqueous source 102 which is returned to the environment depleted of lithium (i.e. lithium depleted stream). The withdrawal process may be an adsorption/desorption process such as a counter-current adsorption/desorption. Where the lithium selective medium is a solid, the lithium selective medium, loaded with lithium ions withdrawn from the aqueous source 102, is contacted with an aqueous eluent 106, which unloads the lithium ions from the lithium selective medium to yield a lithium extract 108. Where the lithium selective medium is a liquid, the lithium selective medium, loaded with lithium ions withdrawn from the aqueous source 102, is contacted with an aqueous stripping fluid, with intense mixing, to transport lithium ions from the lithium selective medium into the aqueous stripping fluid to yield the lithium extract 108. Where the medium is a liquid, a separate lithium unloading vessel may be used as part of the extraction stage to contact the loaded medium with the eluent.

Where the medium is a solid ion withdrawal material (such as metal oxide, metal hydroxide or such material mixed with a resin), the medium may be stationary or fluidized within the vessel, or conveyed through one or more vessels or zones for contacting with the brine, for example in a counter-current format. In particular, the medium may be contained in a plurality of vessels in flow communication with one another and the vessels may be fluidly connected with a plurality of zones (ie inlets/outlets) during the extraction process. The extraction may therefore take place continuously, for instance loading resin in a first vessel with lithium by fluidly connecting this vessel with the brine source while unloading resin in a second vessel by fluidly connecting the second vessel with the eluent and washing a third vessel using a strip solution. The extraction may be a continuous counter-current adsorption desorption (CCAD) process. An example of a counter-current adsorption desorption that may be used is described in U.S. Pat. No. 11,365,128 from EnergySource Minerals.

In either case, the extraction stage 104 yields an aqueous lithium extract 108 and a lithium depleted stream 110. Because the extraction stage 104 uses a lithium selective medium, impurities such as sodium, magnesium, and calcium remain in the lithium depleted stream 110.

The extract may have an arbitrary concentration of ions, up to the solubility limit of the ions, depending on how much eluent is used to contact the loaded withdrawal medium. Flow rate of the eluent can be used to target a concentration of target ions (such a lithium) in the extract. In one case, flow rate of the eluent can be set based on flow rate of aqueous material contacted with the withdrawal material.

The extraction stage that has been described hereinabove is performed using a ion withdrawal method but may include any techniques that extract lithium material directly from brines, and may include solvent extraction techniques and/or ion withdrawal, such as ion exchange and/or adsorption/desorption techniques. Direct lithium extraction, or direct extraction of other critical ions, may also be performed using an electrical separation process that employs a selective membrane. Direct extraction using the processes described herein can also recover nickel, cobalt, manganese, copper, potassium, iron and other ions.

An electrical separation process that employs a selective membrane is briefly disclosed herebelow. In such process, the aqueous ion containing stream (ie aqueous source) is disposed in a first volume contacting a first side of the membrane and an aqueous recovery material is disposed in a second volume contacting a second side of the membrane, opposite from the first side. An electric field is established within the first and second volumes across the membrane to drive ion transport. Selectivity of the membrane results in an aqueous stream having the ions of choice concentrated with respect to, or entirely separated from, other ions. Once the electrochemical separation process has been performed, the ion containing stream forms an ion depleted stream and the aqueous recovery material forms the extract. Some such processes can be impacted by sulfide species, so where applicable any sulfides present may be removed prior to performing direction aqueous extraction of ions, as described in the following.

The lithium extract 108 is routed to a conversion stage 109 to convert lithium in the lithium extract 108 to lithium hydroxide. The conversion stage 109 has a vessel 120 that contains a barrier 122, such as a membrane or diaphragm, which may be selective for lithium, and which separates the vessel 120 into a first volume 124 and a second volume 126. In cases where the barrier 122 is a membrane, the membrane typically allows solutes to pass through more than water so little water passes through the membrane. In cases where the barrier 122 is a diaphragm, the diaphragm typically allows more water to pass through than does a membrane. In each case, membrane or diaphragm, the barrier 122 can be selective for lithium such that lithium is allowed to pass through at a higher rate or quantity than other species. In some cases where a membrane is used, the membrane may be permselective. Where a diaphragm is used, the diaphragm may be microporous.

A cathode 130 is disposed in the first volume 124 and an anode 128 is disposed in the second volume 126. The anode 128 and the cathode 130 are connected to an electric potential 131 to create a voltage within the vessel 120. The lithium extract 108 is routed to the first volume 124, and a water stream 132 is routed to the second volume 126. The powered cathode 130 oxidizes chloride ions to chlorine gas within the first volume 124. The chlorine gas is collected at a first gas outlet 134 of the vessel 120. Lithium ions penetrate the barrier 122, selectively if the barrier is selective for lithium, traveling from the first volume 124 to the second volume 126. The powered anode 128 electrolyzes water to protons and hydroxyl ions. The hydroxyl ions react with the lithium ions in the second volume 126 to form lithium hydroxide which eventually precipitates within the second volume 126. Hydrogen ions join to form hydrogen gas (H₂), which is collected at a second gas outlet 136 of the vessel. The hydrogen gas can be used for any suitable purpose. In one embodiment, the hydrogen gas can contribute to power generation for the process 100 to maximize energy efficiency.

Voltage applied to the materials in the vessel 120, and composition and residence time of the materials in the first volume 124 and the second volume 126 can be adjusted to control the rate of conversion of lithium ions to lithium hydroxide. The rate at which the barrier 122 passes lithium ions depends on properties of the barrier 122 but also composition of the lithium extract 108 in the first volume 124 and the second volume 126. Larger concentration gradient of lithium ions across the barrier 122 boosts transport rate of lithium ions. Slower flow rate of the lithium extract 108 into the first volume 124 provides more time for lithium ions to migrate across the barrier 122, which tends to lower the concentration of lithium ions in the first volume 124. Larger electric potential tends to provide more hydroxyl ions to react with lithium ions, generally lowering the concentration of lithium ions in the second volume 126 and supporting an elevated rate of lithium transport across the barrier 122.

A lithium and chloride depleted aqueous stream 138 is withdrawn at a first liquid outlet 140 of the vessel and a lithium hydroxide material 142 is withdrawn at a second liquid outlet 144 of the vessel 120. As shown in FIG. 1, the lithium and chloride depleted aqueous stream 138 can optionally be returned to the extraction stage 104 for use as the eluent 106, or a portion thereof, in a recycle eluent 146. Some or all of the recycle eluent 146 can be recycled into the lithium extract 108, instead of being recycled to the extraction stage 104. Recycling some or all of the lithium and chloride depleted aqueous stream 138 can recover lithium that exits the conversion stage 109 without being converted to lithium hydroxide.

The conversion stage 109 converts lithium ions, in solution with mostly chloride ions, into lithium hydroxide. The lithium hydroxide stream 142 is typically a solution of lithium hydroxide in an aqueous medium that bears some dissolved lithium hydroxide. The lithium hydroxide material 142 can be routed to uses suitable for such a product, such as battery manufacturing. If desired, water can be removed from the lithium hydroxide material 142, by evaporation, membrane separation, or other convenient process, in a water removal stage 150 to yield a solid or paste lithium hydroxide product 154. The removed water 152 can be routed to the extraction stage 104 to be used with, or as, the eluent 106, optionally along with the recycle eluent 146.

An optional concentration stage (not shown) can be used between the extraction stage 104 and the conversion stage 109 to increase concentration of lithium and chloride provided to the conversion stage 109. The concentration stage can remove water from the lithium extract 108, for example by evaporation or membrane separation such as counter-flow reverse osmosis, either of which may utilize lithium selection techniques such as lithium selective membranes, use of ion separation media such as lithium selective beads, particles, or gels, solids removal, precipitation, or a combination thereof, to form a lithium concentrate that is routed to the conversion stage 109. Water removed from the lithium extract 108 can be recycled to the extraction stage 104 in a manner similar to recycling of the lithium and chloride depleted aqueous stream 138.

For instance, a membrane separation operation used in a concentration stage can include a reverse osmosis process, a counter-flow reverse osmosis process, or both to produce the concentrate and a diluted stream. The diluted stream may be used in other parts of the process such as the extraction stage. The diluted stream may be for instance used as eluent in the extraction stage. Recycling useful aqueous streams generally limits the need to use fresh water at various stages of the process. The concentration stage is typically configured to produce a concentrate having TDS (total dissolved solids) of at least 100,000 mg/l, such as 100,000-200,000 mg/l, for example 120,000 mg/l. Depending on solubility limits of ions in the aqueous medium, TDS in the concentrate may be over 200,000 mg/l. In some cases, however, the concentration stage may be configured to produce a concentrate having lower TDS, for example as low as 35,000 mg/l. Any configuration can be used to produce a concentrate having TDS from 35,000 to 200,000 mg/l.

Counter-flow reverse osmosis is a separation process that uses multiple stages of separation medium to accomplish stagewise separation of ions from water in an aqueous medium. Each stage has a separation medium, which can be any of the media described above, in any of the physical configurations described above, many of which are known. The concentrated output of one stage, produced by separation of ions, penetration of water through a barrier, or other separation process, is routed to the next stage in a first direction. The remaining stream, which is diluted with respect to a target ion, is routed to the next stage in a second direction opposite from the first direction. Thus, the progressively concentrated streams flow in a concentration direction through the process and the progressively diluted streams flow in a dilution direction through the process.

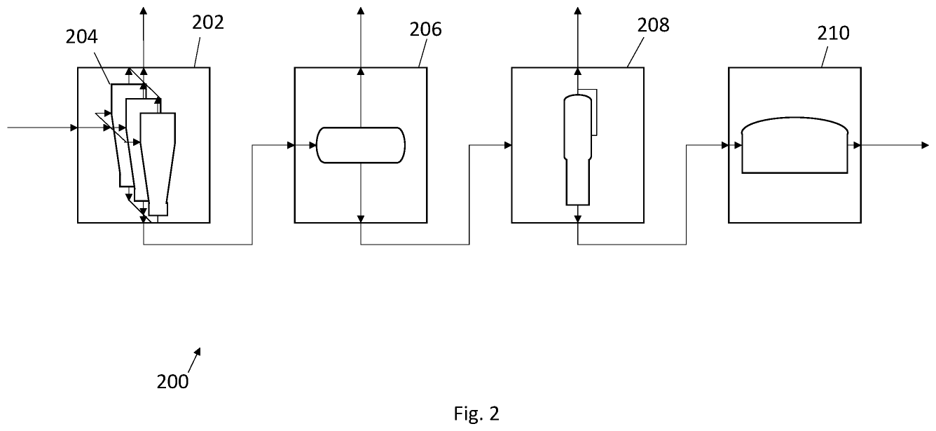

An optional impurity removal stage (not shown) can be used between the extraction stage 104 and the conversion stage 109, in order to reduce the quantity of species other than lithium in the lithium extract and/or concentrate. Such impurity removal stage may include removal of transition metals, silica, and/or divalent ions such as calcium, magnesium, aluminum, manganese or iron, to the extent such ions are not target ions for recovery. The impurity removal stage can be before or after the concentration stage or the extraction stage, and may use any suitable chemical or physical method, depending on the nature of the impurities to be removed. Methods such as chemical reaction, precipitation (via concentration or coagulation-flocculation), solids removal, ion exchange, filtration, digestion, and any combination thereof, can be used. The method may also include optional concentration and/or impurity removal before the extraction stage 104, as will be for instance described in more details in relationship with FIG. 2.

As noted above, chlorine gas (Cl₂) is collected at the outlet 134 of the conversion stage into a chlorine gas stream 112. The chlorine gas is contacted with the lithium depleted stream 110 in a bromine production stage 114, where chlorine is reduced to chloride ions and bromide ions are oxidized to elemental bromine (Br₂). Chlorine gas for the bromine production stage 114 may be entirely sourced from the conversion stage 109 or other gases may be mixed with the chlorine gas from the conversion stage 109 to make the chlorine gas stream 112. For example, chlorine gas from another source may be added to the chlorine gas stream 112 to adjust the amount of chlorine gas in the chlorine gas stream 112. Additionally, or instead, a gas that is not reactive in the process 100, for example nitrogen gas or carbon dioxide, can be added to the chlorine gas stream 112 to adjust the total flow rate of the chlorine gas stream 112.

The bromine production stage 114 may include a vessel 116 in the lithium depleted stream 110 is contacted with the chlorine gas stream 112. The vessel can be a container like a tank or drum with inlet and outlet flow ports, or the vessel can be a pipe. Mixing can be applied, if desired, using any mixing process or equipment, such as a powered agitator for a tank or drum or an in-line mixer (static or dynamic) for a pipe reactor. The bromine production stage 114 can be operated at a temperature above the boiling point of bromine to provide easy separation of bromine gas from the liquid contents of the bromine production stage 114. Where the vessel 116 is a tank, a vapor space can be maintained inside the vessel 116 to support removal of bromine gas from the vessel 116.

The bromine gas is removed from the vessel in a bromine stream 118. The bromine stream 118 may be removed from a high point of the vessel 116, or since bromine gas is relatively dense from a location below the high point of the vessel 116 that does not risk entraining liquid from the vessel 116 with the bromine gas. The bromine gas can be condensed such that the bromine stream 118 is a liquid material. Since bromine is only slightly soluble in most aqueous media, any co-condensed materials are likely to be immiscible with liquid bromine so that the condensed liquid bromine can be withdrawn as a separate liquid phase.

The bromine production stage 114 may include additional vessels and treatments, for example to purify bromine recovered from the vessel 116 or to convert the recovered bromine into a solid product such as sodium bromide. Purification of bromine gas can include condensing the bromine gas and separating liquid phases to remove water or other impurities. Conversion of bromine into a solid bromide product typically includes adding a redox reagent to reduce the bromine to bromide ions, potentially using cations likely to precipitate bromide. Sodium salts such as sodium sulfate can be used. Lithium hydroxide from the conversion stage 109 can also be reacted with the bromine gas to form solid lithium bromide. Numerous solid bromide products can be made using the elemental bromine provided by the bromine production stage 114.

An aqueous lithium and bromide depleted stream 119 is removed from the bromine production stage 114. The lithium and bromide depleted stream 119 comprises mainly metal cations such as sodium, potassium, calcium, and magnesium, along with chloride anions and trace other components. The process 100 uses, as general inputs, an aqueous stream comprising lithium ions and bromide ions, water stream 132, and eluent 106, which can be water or a dilute solution of lithium or other ions. Depending on the water balance of the process 100, total ions concentration (total dissolved solids, or “TDS”) may be lower in the lithium and bromide depleted stream 119 than in the aqueous source 102, and concentration of chloride ions may be lower as well.

The process 100 uses power to generate an electric potential difference in the vessel 120 of the conversion stage 109. The hydrogen gas stream withdrawn from the conversion stage 109 may be used to generate power for the conversion stage 109 to increase energy efficiency. Overall, the process 100 uses, as inputs, the aqueous source 102, the water stream 132, the eluent 106, and power from any reasonable power sources and generates, as outputs, the lithium hydroxide material 142 or optionally the lithium hydroxide product 154, the bromine product 118, the lithium and bromide depleted stream 119, and potentially the lithium and chloride depleted stream 138.

The process 100 can, optionally, include a bromine removal stage 160 to treat an aqueous lithium and bromide containing stream 101 and remove bromine to a bromine product 162. A portion, or all, of the chlorine gas stream 112 can be routed to the optional bromine removal stage 160. In general, the chlorine gas stream 112 can be used to produce bromine from any bromide-containing aqueous stream of the process 100 or of another process. For example, bromine could be generated using an aqueous bromide source from another process, or using an intermediate stream withdrawn from the vessel used to contact the aqueous source 102 with the lithium selective medium in the extraction stage 104. Where the optional bromine removal stage 160 is used, the extraction stage 104 could also be omitted in some cases, and the conversion stage 109 used to directly convert lithium chloride from the aqueous source 102 into lithium hydroxide using the electrochemical process described above for generating the chlorine gas stream 112.

The chlorine gas can also be used to remove sulfides from any sulfide-containing stream of the process 100 by reacting with sulfide species to form sulfur and hydrochloric acid (HCl) or of another process described herein or another process not specifically described herein. The sulfur can subsequently be filtered out of the bromide depleted stream. For example, the chlorine gas can be mixed with the aqueous source 102 in the optional bromine removal stage 160 to remove sulfide species and bromide ions in a single treatment or in a staged treatment. The chlorine gas can also remove sulfide species in the bromine production stage 114 or in the optional bromine removal stage 160, or in other units.

It should be noted that the process 100 can also be configured to deliver a lithium carbonate final product by providing a second conversion stage (not shown) in which the lithium hydroxide material 142 is reacted with sodium carbonate to form lithium carbonate, which can be precipitated, filtered, concentrated, and/or solidified by removing water using any convenient process.

An aqueous source may contain ions of interest such as lithium, manganese, nickel, cobalt, magnesium, iron, copper, zinc, vanadium, molybdenum, or other critical and non-critical ions, and may have sulfide species, dissolved gases, bacteria, species that can cause scaling, fouling, or corrosion, organic species (ie species containing carbon atoms such as but not limited to hydrocarbons and carbon dioxide), or a combination thereof. Direct aqueous extraction of the ions selectively extracts specific ions (ions of interest) from an aqueous source as has been explained in relationship with FIG. 1.

In some cases, it can be useful to remove impurities such as hydrocarbon, or other organics, and sulfide species from aqueous materials in a process of recovering valuable metals, such as lithium, from the aqueous materials. Methods of recovering critical ions such as lithium from an aqueous source typically include several stages and in particular a direct aqueous extraction stage. An example of such method has been disclosed in relationship with FIG. 1. Methods described herein also include reducing the concentration of sulfide species such as hydrogen sulfide (H₂S), bisulfide (HS⁻), and/or sulfide (S²⁻) species in an aqueous material to be used in the extraction stage. Methods described herein also include reducing the concentration of organic species, including hydrocarbons, bacteria, and salts in an aqueous material to be used in the extraction stage. Some methods include a combination of methods such as reducing (including, reducing to zero) sulfide species and/or reducing organic species such as hydrocarbons. Such methods can also be combined with bromine removal and recovery as described above as bromide species may be present along those species. For instance, Smackover brine includes bromide and sulfide species.

Here below are described methods to remove impurities that may be used in combination with the method of FIG. 1. For instance, sulfide species and/or organics species and/or transition metal ions can be removed from the aqueous source before the extraction stage 104 of FIG. 1 and/or before the bromine removal stage 114 or 160.

Such impurities may indeed be detrimental in the extraction stage as they may reduce efficiency of the extraction process. They may also be detrimental in the bromine production process. Indeed, the chlorine gas may react with other compounds, such as sulfide species as indicated above and/or transition metals ions that it can fully oxidize. It generally reacts with those compounds before reacting with bromide ions. In order to maximize the reaction of chlorine gas and bromide ions, said other compounds may be removed before producing bromine.

Reducing concentration of sulfide species in an aqueous material may include use of gas sparging in an open or closed system, membranes, adsorber media (such as the product SULFATREAT™ available from Schlumberger, Ltd.) chemical treatment, or any combination thereof. Reducing concentration of sulfides may include displacing sulfide species, oxidizing sulfide species using a chemical agent, or both. Displacing sulfide species can use air or inert gas, such as nitrogen, or both for displacing sulfide species out of the aqueous source or other aqueous stream to be used for direct aqueous extraction. Gas sparging is an example of a displacement technique in which a gas is flowed into a liquid containing sulfides, causing the sulfides to leave the liquid with the gas as the gas bubbles out of the liquid. The gas emerging from the liquid, and bearing sulfide species, can be routed to a flare or other combustion device, or to a sequestration system such as the SULFATREAT™ (mark of Schlumberger or a Schlumberger company) system available from Schlumberger, Ltd., of Houston, Texas, or an amine scrubbing system. Sulfide species may also react with other native species found in the brine for example iron. This may involve a redox couple between a sulfur containing species and iron species or mediated by a biological agent. Reducing concentration of sulfide species in an aqueous material may also include use of a bio treatment process in which a biological agent, such as an organism, enzyme, or molecule that is a biologically active or living agent or derived from a biologically active or living agent, is used to remove sulfide species, or facilitate removal of sulfide species, from the aqueous material. Where bromine is also removed, bromine removal and recovery can be performed before or after removal of other impurities such as organics and sulfides.

Oxidizing sulfide species using a chemical agent may be configured so that the chemical agent reacts with sulfide species, such as H₂S, to yield in some reactions sulfuric acid (H₂SO₄). Any appropriate chemical agent may be used to oxidize sulfide species, and such chemical agent may be combined with other additives or catalysts, of which iron is one example. An exemplary composition that could be used to treat the brine is described in US Patent Application 2014/0374104, herein incorporated by reference. Triazines are also known sulfide removal agents, so various triazines, such as hexahydro-1,3,5-tris(hydroxyethyl)-s-triazine (MEA triazine) or hexahydro-1,3,5-trimethyl-s-triazine (MMA triazine) could be used to scavenge sulfide species from an aqueous stream. Another chemical agent known to remove sulfide species is (ethylenedioxy)dimethanol. Different chemical agents in combination may also be used to treat different sulfide species.

The sulfide species could be temporarily sequestered from the aqueous source, or a stream derived from the aqueous source such as the extract, and then mixed with the ion depleted stream of the extraction stage. Such methods may be particularly applicable when displacement and/or gas sparging techniques are used. “Derived,” here, means that the stream can be the same stream or a stream that is obtained from processing in another stage. So here, a stream derived from the aqueous source can be a stream of the aqueous source itself, in other words the aqueous source itself, or a stream obtained from processing the aqueous source.

In another embodiment, the sulfide species may be chemically converted to a reagent, for example an acid, and the reagent used in any stage of the method to adjust properties of a stream for processing. An acid formed from the sulfide species may for instance be used to adjust pH of one of the extraction feed and/or of the stream derived from the extraction feed, i.e. before lithium extraction. Here, “derived” means a stream obtained from processing the extraction feed in some respect. As noted above, sulfide species can be converted to sulfuric acid using an oxidant such as sodium hypochlorite. The reaction produces sodium chloride as a byproduct, which can easily be removed at any stage of the methods described herein.

Reducing concentration of organic species, which may be or may include hydrocarbons, can use one or more processes of gravity separation, gas flotation, filtering (e.g. membrane filtering), inducing coalescence, adsorption/desorption, and bacterial or microbial cleaning. FIG. 2 is a process diagram of an example process 200 for removing hydrocarbons and/or other organic species from an aqueous stream. Emulsified oil or an oil phase can be removed using one or more of the techniques listed in Table 1. For instance, bulk oil can be removed using a gravity separator 202, for example by use of one or more hydrocyclones 204. Such bulk oils can include, or can be, condensate, light crude oil, medium viscosity crude oil, high viscosity crude oil, Heavy oil or a combination thereof. Free oil can be removed using a filtration unit 206, which may be a cross-flow scrubber. A cross-flow scrubber can be obtained from Schlumberger Ltd., of Houston, TX. Dispersed oil can be removed by a gas flotation unit 208, which may be an EPCON dual compact flotation unit available from Schlumberger, Ltd. Polishing oil can removed using a second filtration unit 210, which can be a vessel holding a nutshell filter medium such as the HYDROMATION walnut shell filter media available from Schlumberger, Ltd. These units are shown in series, but such units can be configured in any suitable arrangement and/or bypassed or omitted as may be convenient for different processes. Chemical additives can be used to control scale, bacteria, corrosion, formation of emulsions, sulfur species, pH, alkalinity, or other characteristics. Bacterial or microbial treatment, as known in the art, can be used in addition to, or instead of, the techniques described above.

Reducing the concentration of organic species may also include use of granular activated carbon (GAC) as a medium in a filtering process and/or a counter-current adsorption desorption (CCAD) process. Such processes can use media selective to organic species as withdrawal material to withdraw organic species, such as specific target hydrocarbons, from an aqueous stream. Another such media that can be used, in addition or instead, is walnut shell media. Other media that can be used include zeolites, metal-organic frameworks, and/or activated or nonactivated nanotubes. Such media can be used alone, or with other media described herein. Such media can be used in adsorption-desorption processes, for example, to separate organics, including hydrocarbons, from the aqueous stream.

The stage shown here is an example and may comprise additional operations or some operations may be removed depending on the nature of the contaminants. For instance, in some cases only bulk oil and dispersed oil may be removed, or only bulk oil and free oil, or only polishing oil, etc. Any combination of the operations above is covered by the present disclosure, and the equipment described below for each operation represents examples of equipment that can be used to perform the various operations. Appropriate additives can be added to the aqueous material (containing some type of oil) before one or more of the operations in order to enhance removal operations. Such additives may include any of the chemical additives enabling one or more of scale control, prevent bacteria or corrosion development, destabilize emulsions, adjusting pH or alkalinity, etc. The additives used may include any conventional additives and may be chosen in view of characteristics, such as temperature and impurity type and quantity, of the aqueous material.

Table 1 shows characteristics of types of non-dissolved oil (ie emulsified oil or oil phase) that can be removed or reduced in an aqueous material by the units of FIG. 2.

TABLE 1
Aqueous Oil Removal

| Oil Type | Particle Size | | Concentration | | Products | Technology |
|---|---|---|---|---|---|---|
| Bulk Oil | >120-150 | μm | >200-2000 | ppmv | Unicel ® vertical skim, | gravity |
| | | | | | Vortoil ® presep. | |
| | | | | | Hydrocyclone, | |
| | | | | | Compact Flotation | |
| Free Oil | >40 | μm | >40-200 | ppmv | Wemco ® Pacesetter ®, | Coalescence, |
| | | | | | NATCO cross-flow | gravity, |
| | | | | | scrubber, Vortoil deoiling | centrifugal |
| | | | | | hydrocyclone, Voraxial | force |
| | | | | | separator | |
| Dispersed | >10 | μm | >10-40 | ppmv | Wemco ISF, Wemco | Air bubbles, |
| Oil | | | | | Depurator, Unicel | gas flotation |
| | | | | | vertical IGF, TST CFU ™. | |
| | | | | | EPCON compact | |
| | | | | | flotation | |
| Polishing | >5 | μm | >1-10 | ppmv | Petreco ® Hydromation ® | Media filtration |
| | | | | | nutshell filter, Wemco | |
| | | | | | Silver Band nutshell filter | |

Each type of oil is characterized by a particle size (first column) and a concentration in the brine (second column). When there are different types of oil in the brine, the oil that has the larger particle size is generally removed first. The products that are indicated in the third column of Table 1 are commercial products, some of them available from Schlumberger, Ltd., that can perform the specified oil removal operations.

In addition to the non-dissolved organics, dissolved organic materials can also be removed using organic selective media, which can be solid, liquid, or gel. Many such materials are known in the art, and can be used for contacting with an aqueous stream containing dissolved organic materials. Such dissolved organic materials can include materials that partition from oil to water phase, such as acids and amines, and organic inhibitors for scale prevention, corrosion management, bacterial control, and emulsion control.

Reducing organics in the aqueous material to be used for ion recovery can also be performed by membrane processes, which can utilize electrical, chemical, pressure, vacuum, biological agents such as bacteria, or surface modification of a medium for removing organic species, including hydrocarbons,

If reducing concentration of sulfide species and of hydrocarbons/organics are both performed, reducing concentration of hydrocarbons/organics can be performed before reducing concentration of sulfide species. Alternately reducing concentration of sulfide species can be performed before reducing concentration of hydrocarbons/organics. Depending on the processes used for the two removal operations, it may be preferable, in some cases, to perform one removal before the other, but the two operations can generally be performed in any order.

Other stages may be performed before lithium extraction, including removing transition metals and/or suspended solids and bromine removal and recovery. Such operations can be performed in any order with organic and sulfide removal. As before, depending on the processes used for the various removal/recovery stages, it may be preferable to perform some operations before others. Removing suspended solids may include any appropriate technique, for instance filtering techniques and/or use of desanders, desilters, and/or hydrocyclones. Removing transition metals may include methods such as chemical reaction, precipitation (via concentration or coagulation-flocculation), solids removal, ion exchange, filtration, digestion, and any combination thereof.

The methods described herein may also include reducing the concentration of dissolved silica before extraction (and/or after extraction). When performed before extraction, this is preferably performed after reducing the concentration of hydrocarbons and/or organics and/or reducing the concentration of sulfide species but the stages before lithium extraction can generally be performed in any order. Any conventional technique for removing silica may be implemented including use of chemical agent such as lime softening or iron hydroxide or adsorption methods. Other minerals that may have detrimental impact on the extraction process can also be removed using known processes. In one method, the aqueous material may be subjected to a concentration operation to increase concentration of a detrimental species beyond its solubility limit to cause that species to precipitate as a solid that can then be removed from the aqueous material. Where appropriate, the aqueous stream can also be combined with fresh water to dilute detrimental species, such as scaling species, that can be tolerated below a threshold concentration. When applicable and/or useful, heat maybe added or removed from the brine entering or leaving the process via heat exchangers plus any other stream in the process.

One example of an aqueous source that can be advantageously treated using the methods described herein is Smackover brine, which can contain sulfide species and bromide species. Such a brine may be treated to remove bromine and/or bromide species prior to ion recovery. Other brines that can be treated using these methods generally include salar brines, continental brines, oilfield brines, produced water streams, geothermal brines, seawater sources, or any combination thereof. The methods herein are useful for reducing sulfide and organic species that can be found in such brines and for then recovering target ions from the aqueous source.

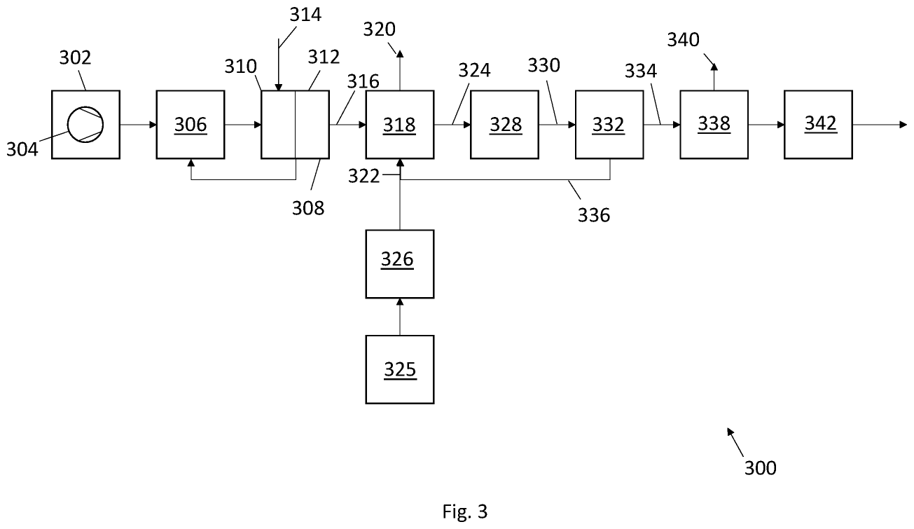

FIG. 3 is a process diagram summarizing a method 300 according to one embodiment. An aqueous source 302 contains an aqueous material that is to be treated using the process of the method 300. A pump 304, which may be a submersible pump, obtains aqueous material from the aqueous source 302 and disposes the aqueous material in a tank 306 for storage and/or buffering.

The aqueous material is withdrawn from the tank 306 and routed (e.g. using a pump, not shown) to a preparation stage 308 for removal of sulfide species and organic species, such as hydrocarbons, as well as transition metals. The preparation stage 308 may have a reaction part 310 and a filtration part 312, substantially as described above. In this case, an additive stream 314 is provided to the reaction part 310 to react with sulfide species in the aqueous material. The aqueous material is contacted with filtration media, such as nutshells, granulated activated carbon, and/or bacterial organic consumers, in the filtration part 312 to remove or reduce organic species. Any or all of the units described in connection with FIG. 2 may be included in the preparation stage 308 to remove organic species or transition metals.

A purified aqueous material 316 exits the preparation stage 308 and is provided to an extraction stage 318, which can be any embodiment of extraction stage described herein. In this case, a withdrawal material is used to withdraw ions from the purified aqueous material 316 in a loading process such as any of the loading processes described herein, resulting in a depleted stream 320, which can be returned to the environment. Optionally, impurities and water can be separated in the depleted stream 320, and the water can be used elsewhere in the process of the method 300, or for any suitable purpose.

When an endpoint of the loading process is reached, for example when the withdrawal material is saturated with target ions, such as lithium, or at a time before such saturation point, contacting the withdrawal material with the purified aqueous material 316 is discontinued. In one case, the purified aqueous material 316 can be recycled to the tank 306 during such phase. An eluent 322 is used to unload ions from the withdrawal material to yield an extract 324. The eluent 322 is sourced, at least in part, from a fresh water tank 325, and may be treated in a purification stage 326 to remove any impurities that might negatively impact the extraction process.

The extract 324 is routed to an impurity removal stage 328 to remove impurities such as dissolved silica, hardening species, and transition metals, if desired, as described elsewhere herein. The impurity removal stage 328 yields a purified extract 330 that is provided to a concentration stage 332, which produces a concentrate 334 significantly higher in concentration of target ions. Water separated in the concentration stage 332 emerges as a diluted stream 336, which may include small amounts of ions and is recycled, in this case, to the extraction stage 318 to combine with water from the fresh water tank 324 to form the eluent 322. The concentration stage 332 may utilize energy recovery and integration between hot streams and cool streams to minimize energy input into the concentration operation. The concentration stage 332 produces a concentrate that may for instance be 4 wt % or more, for example 5 wt % or 10 wt % or 15 wt %, target ions, depending on the solubility of the target ions in water. In a lithium embodiment, the concentrate may have 4 wt % lithium, but could have more lithium because the solubility limit of lithium ions in water is much higher than 4 wt %. The concentration stage 332 can use membrane separation, evaporation, or a combination thereof. Heat can be recovered from the liquid remaining after evaporation, and streams subjected to membrane processes can be depressured to yield energy.

The concentrate 334 obtained from the concentration stage 332 is routed to a storage tank 338, where the concentrate 334 can be used as a product 340 or routed to a conversion stage 342 for conversion to carbonate, hydroxide, or both as described above. Where a conversion process is used that forms chlorine gas, Cl₂, such as an electrochemical conversion to hydroxide, the chlorine gas can be used to recover bromine in any part of the process containing bromide ions. For example, the chlorine gas can be recovered at the conversion stage 342 and routed to the tank 306 or into the conduit through which aqueous material from the source 302 flows into the tank 306. As noted above, the chlorine gas will react with bromide ions to produce elemental bromine, which can be collected as a liquid at the bottom of the tank 306 and recovered. Alternately, the chlorine gas produced at the conversion stage 342 can be routed to another stream containing bromide ions to recover bromine.

The lithium-selective extraction processes described herein can be used to extract, concentrate, and purify other elements, such as nickel, manganese, magnesium, and cobalt, zinc, aluminum, copper, molybdenum, vanadium, or any combination thereof. Generally, where the processes herein are described as lithium-selective, materials can be used to make the same processes selective for other target ions, such as those listed above. The preparation stage may include removal of sulfides and/or organics as well as a combination of any impurity that is described in a specification as has been described in relationship with lithium. The resulting extract can then be subjected to impurity removal stage and/or concentration stage that is substantially the same as the processes described herein.

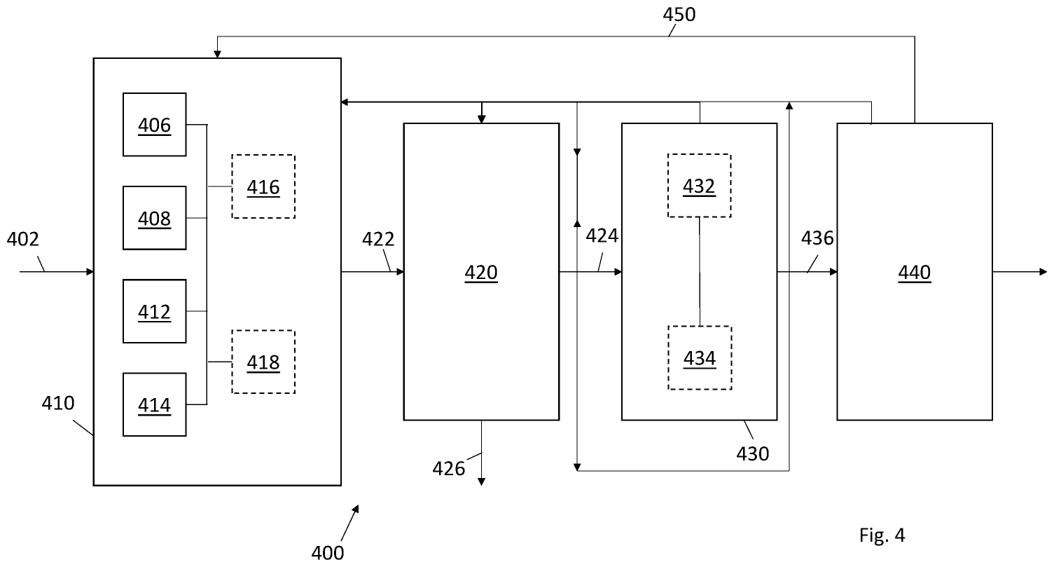

FIG. 4 is a schematic process diagram of an ion recovery process 400 according to another embodiment. The process 400 is a general process that includes stages described elsewhere herein. An aqueous source 402 is provided to a preparation stage 410. The preparation stage 410 includes a solids removal unit 406, an organic removal unit 408, a sulfide removal unit 412, and a bromine recovery unit 414. The preparation stage 410 can also include an optional concentrator 416. The preparation stage 410 can also optionally include a divalent removal unit 418, which can remove divalent cations from the aqueous source 402 prior to downstream ion recovery operations if such removal is suitable and advantageous. The concentrator 416 can be used to manage performance of downstream ion recovery operations. The various units of the preparation stage 410 can be aligned and/or configured to operate in any suitable order, depending on the needs of particular processes. Treatments can be performed on streams within the preparation stage 410 to adjust characteristics of any stream for suitable processing. For example, temperature, pH, ionic strength, salt content, and other characteristics can be adjusted at any suitable point.

The preparation stage 410 yields an extraction feed 422, which is routed to an extraction stage 420. In the extraction stage 420, target ions are extracted using any of the methods described herein. As mentioned above, the optional concentrator 416 can adjust concentration of ions in the extraction feed for optimal processing in the extraction stage 420. As noted above, the extraction stage 420 can perform direct ion extraction using a medium to remove ions from the extraction feed 422 and an eluent to remove ions from the medium. The extraction stage 420 generally yields an extract 424, which can be an eluate of a direct ion extraction process as described herein, containing a target concentration of the target ions, and a depleted stream 426, which is generally depleted of the target ions. In some cases, the target ions may be substantially completely removed from the extraction feed 422 to yield a depleted stream 426 having undetectable amounts of the target ions.

At this point, the extract 424 can be used for any suitable purpose. In the process 400, an optional conversion preparation stage 430 can be used to prepare the extract for optimal conversion to one or more products. The conversion preparation stage 430 can include an impurity removal unit 432. The conversion preparation stage 430 can also include a concentration unit 434. The conversion preparation stage 430 can include one or both of the impurity removal unit 432 and the concentration unit 434. The units of the conversion preparation stage 430 are described elsewhere herein, and can be utilized within the conversion preparation stage 430 in any suitable order. The extract 424 can be provided to the conversion preparation stage 430, which yields a conversion feed 436.

The extract 424, the conversion feed 436, or both, or any portion of either, in any combination, can be provided to a conversion stage 440 that generally converts target ions in the extract 424, the conversion feed 436, or both into products. One example of a target ion is lithium, which can be converted, in the conversion stage 440, into lithium carbonate, lithium sulfate, lithium nitrate, lithium hydroxide, or any suitable product. Units of the conversion stage 440 are described elsewhere herein. Where bromine removal and recovery is performed in the preparation stage 404, a source of chlorine gas 450 is provided to the preparation stage to convert bromide ions in the aqueous source 402, or a stream derived from the aqueous source 402 by processing in the preparation stage 404, into bromine. The source of chlorine gas 450 can be any source, but where lithium in the extract 424, the conversion feed 436, or both is converted to lithium hydroxide in the conversion stage 440 according to methods described herein, the source of chlorine gas 450 can be provided by the conversion stage 440, as shown in FIG. 4. As such, chlorine gas can be recovered in the conversion stage 440 and routed to the preparation stage 404 for use in recovering bromine from the aqueous source 402. The conversion stage 440 produces one or more products 460, which may be utilized in any convenient way.

Any of the stages and units of the process 400 may form aqueous streams, which may be dilute ion streams or substantially pure water streams. For example, concentrators, impurity removal units, and the like can form aqueous streams that can range from substantially pure water to dilute brines. Any of these streams can be recycled to a convenient upstream part of the process 400. For example, aqueous streams produced by downstream processing can be routed to the preparation stage 404 to manage the concentration of target ions in any stream of the preparation stage 404, including the extraction feed 420. Alternately or additionally, aqueous streams produced by downstream processing can be routed to the extraction stage 404 to be used as, or as part of, an eluent for direct ion extraction.

The methods described herein, thus, include generating chlorine gas in a conversion process that converts metal chloride from an metal containing aqueous medium obtained from an aqueous source into a hydroxide material; recovering the chlorine gas; and recovering bromine by reacting the chlorine gas with a bromide containing aqueous source.

The conversion process can be a lithium conversion process that converts lithium chloride to a lithium hydroxide material.

The lithium conversion process is an electrochemical process, in one case, that uses an anode and a cathode, wherein chlorine gas is generated at the anode from chloride ions of the aqueous medium. The anode and cathode can be separated by a selective barrier, for instance selective for lithium.

The methods herein can also include separating a target metal, such as lithium of an extraction feed derived from the metal containing aqueous source using a direct extraction process to form an extract, wherein the aqueous medium is derived from the extract and wherein the metal of the metal chloride is the target metal. The methods can also include concentrating a stream derived from the extract to form a concentrate, wherein the aqueous medium is derived from the concentrate.

In some cases, the extraction feed can be the aqueous source. The direct extraction process yields a lithium depleted stream, and the lithium depleted stream can be the aqueous source in some cases. In other cases, reacting the chlorine gas with the bromide containing aqueous source yields a bromine product and a bromide depleted stream, wherein the extraction feed is derived from the bromide depleted stream.

Water can be removed from the hydroxide material, for instance lithium hydroxide material, to form a solid hydroxide product. The hydroxide material may also be in one embodiment further converted into a carbonate product.

In an embodiment, the methods include one or more of reducing a concentration of sulfide species, optionally hydrogen sulfide (H2S), bisulfide (HS−), sulfide (S2−), or any combination thereof, or reducing a concentration of organic species, optionally a hydrocarbon, or reducing a concentration of transition metal ions, preferably other than the target metal, in a first stream, wherein the bromide containing aqueous source and/or the extraction feed is derived from the first stream.

In another embodiment, the bromide depleted stream includes sulfide species, wherein reacting the chlorine gas with the bromide depleted stream also yields a sulfur product, wherein the method includes removing the sulfur product from the bromide depleted stream.

Reducing the concentration of organic species may use one or more of gravity separation, electrochemical separation, chemical treatment, bacterial treatment, gas flotation, filtering, inducing coalescence and adsorption-desorption. In an embodiment, the organic species includes non-dissolved oil (such as emulsified oil or an oil phase) and reducing the concentration of non-dissolved oil uses a gravity separation process, a filtering process, a gas flotation process, or a combination thereof. In particular, the organic species includes bulk oil, free oil, dispersed oil, polishing oil, or any combination thereof. In an embodiment, the organic species includes bulk oil and reducing the concentration of bulk oil uses a gravity separation process. In an embodiment, the organic species includes free oil and reducing the concentration of free oil uses a filtering process. In an embodiment, the organic species includes dispersed oil and reducing the concentration of dispersed oil uses a gas flotation process. In an embodiment, the organic species includes polishing oil and reducing the concentration of polishing oil uses a filtering process. Additionally or alternatively, the organics species includes dissolved organic materials and reducing the concentration of dissolved organics includes using organic selective media, which can be solid, liquid, or gel. In an embodiment, reducing the concentration of organic species includes using granular activated carbon in a filtering process, a counter-current adsorption-desorption process, or both. Such processes can use media selective to organic species as withdrawal material to withdraw organic species, such as specific target hydrocarbons, from an aqueous stream. Another such media that can be used, in addition or instead, is walnut shell media. Other media that can be used include zeolites, metal-organic frameworks, and/or activated or nonactivated nanotubes.

The methods herein can also include removing suspended solids from the aqueous source, extraction feed, a stream obtained from the extraction feed, or any combination thereof. In particular, removing suspended solids may be performed before reducing the concentration of organic species. Removing suspended solids may include filtering the lithium aqueous source and/or extraction feed. Concentration of dissolved silica can also be reduced in the aqueous source, the extraction feed, the stream obtained from the extraction feed, the extraction feed, or any combination thereof.

In some cases, reducing the concentration of sulfide species includes displacing the sulfide species, optionally using air or an inert gas, withdrawing the sulfide species using a withdrawal material, oxidizing the sulfide species using a chemical agent or a biological agent, or any combination thereof. The withdrawn sulfide can be routed to a combustion stage, or a sequestration stage, or an amine scrubbing stage. When routed to a sequestration stage, it can be mixed with the ion depleted stream obtained from the extraction stage. In addition to displacing the sulfide species, reducing the concentration of sulfide species can include oxidizing the sulfide species using a chemical or biological agent that reacts with the sulfide species, withdrawing the sulfide species using withdrawal material in an adsorption-desorption process, such as a counter-current adsorption-desorption (CCAD) process, or any combination thereof. The sulfides can be chemically converted to a reagent that can be recycled in some cases. The reagent may be used, for example, to adjust pH of the extraction feed, a stream obtained from the extraction feed, or both. Additionally or alternately, the sulfides can be removed by gas sparging, membranes, adsorber media, chemical treatment, or any combination thereof.

As described above, direct aqueous extraction of ions can include an adsorption/desorption process that may be a counter-current adsorption/desorption. The direct extraction can use a selective withdrawal material configured to selectively withdraw one or more ions into the withdrawal material yield a loaded withdrawal material and an ion depleted stream. In such case, direct aqueous extraction also includes passing an eluent through the loaded withdrawal material to remove ions from the withdrawal material and yield the extract. In particular, the withdrawal material is selective to lithium. In an embodiment, the sulfide species is removed from the stream derived from the aqueous source and mixed with the ion depleted stream. Direct aqueous extraction of ions can, additionally or alternately, use an electrochemical separation process having a membrane selective for the target ion to yield the extract. The electrochemical separation may also yield a lithium depleted stream.

Methods herein may further include concentrating a stream derived from an extract, obtained from an ion extraction process described herein, in a concentration stage to yield a concentrate. Concentrating the extract may include membrane separation, evaporation, or any combination thereof. In one case, concentrating the extract includes membrane separation, and the membrane separation includes a reverse osmosis, a counter-flow reverse osmosis, or both to yield the concentrate and a diluted stream. In such embodiment, the method may further comprise recycling the diluted stream to the extraction stage. In an embodiment, the concentration stage produces a concentrate having total dissolved solids (TDS) over 120,000 mg/l.

The methods may further comprise routing the extract, a stream derived from the extract, or both, to an impurity removal stage to reduce concentration of one or more hardness species, one or more transition metals, one or more divalent impurities, or a combination thereof. The impurity removal stage may reduce concentration of calcium, magnesium, aluminum, manganese, iron, barium, boron, scale-forming salts, or any combination thereof.

In an embodiment, the aqueous source is a salar brine, a continental brine, an oilfield brine, a produced water, a geothermal brine, a seawater source, or a combination thereof. In particular, the aqueous source may be a Smackover brine. In an embodiment, the aqueous source may be a Bakken brine.

The methods described herein can include withdrawing lithium ions from an aqueous medium comprising lithium ions using a direct extraction process to form an aqueous lithium extract; converting lithium ions of the lithium extract to lithium hydroxide using an electrochemical process; converting chloride ions of the lithium extract to chlorine gas using the electrochemical process; and reacting the chlorine gas with an aqueous source comprising bromide ions to form bromine gas from the bromide ions. The electrochemical process can use a lithium selective barrier. Reacting the chlorine gas with the aqueous source can form a bromine depleted stream, and the aqueous medium can be derived from the bromine depleted stream. The direct extraction process can yield a lithium depleted stream, and the aqueous source comprising bromide ions can be derived from the lithium depleted stream. In some cases, the methods can also include one or more of reducing a concentration of sulfide species, optionally hydrogen sulfide (H2S), bisulfide (HS−), sulfide (S2−), or any combination thereof, or reducing a concentration of organic species, optionally a hydrocarbon, or reducing a concentration of at least one transition metal ion, in an aqueous source comprising lithium and bromide ions to form the aqueous medium.

Reducing the concentration of organic species may use one or more of gravity separation, electrochemical separation, chemical treatment, bacterial treatment, gas flotation, filtering, inducing coalescence and adsorption-desorption. In an embodiment, the organic species includes non-dissolved oil (such as emulsified oil or an oil phase) and reducing the concentration of non-dissolved oil uses a gravity separation process, a filtering process, a gas flotation process, or a combination thereof. In particular, the organic species includes bulk oil, free oil, dispersed oil, polishing oil, or any combination thereof. In an embodiment, the organic species includes bulk oil and reducing the concentration of bulk oil uses a gravity separation process. In an embodiment, the organic species includes free oil and reducing the concentration of free oil uses a filtering process. In an embodiment, the organic species includes dispersed oil and reducing the concentration of dispersed oil uses a gas flotation process. In an embodiment, the organic species includes polishing oil and reducing the concentration of polishing oil uses a filtering process. Additionally or alternatively, the organics species includes dissolved organic materials and reducing the concentration of dissolved organics includes using organic selective media, which can be solid, liquid, or gel. In an embodiment, reducing the concentration of organic species includes using granular activated carbon in a filtering process, a counter-current adsorption-desorption process, or both. Such processes can use media selective to organic species as withdrawal material to withdraw organic species, such as specific target hydrocarbons, from an aqueous stream. Another such media that can be used, in addition or instead, is walnut shell media. Other media that can be used include zeolites, metal-organic frameworks, and/or activated or nonactivated nanotubes.

The methods herein can also include removing suspended solids from the aqueous source, extraction feed, a stream obtained from the extraction feed, or any combination thereof. In particular, removing suspended solids may be performed before reducing the concentration of organic species. Removing suspended solids may include filtering the lithium aqueous source and/or extraction feed. Concentration of dissolved silica can also be reduced in the aqueous source, the extraction feed, the stream obtained from the extraction feed, the extraction feed, or any combination thereof.

In some cases, reducing the concentration of sulfide species includes displacing the sulfide species, optionally using air or an inert gas, withdrawing the sulfide species using a withdrawal material, oxidizing the sulfide species using a chemical agent or a biological agent, or any combination thereof. The withdrawn sulfide can be routed to a combustion stage, or a sequestration stage, or an amine scrubbing stage. When routed to a sequestration stage, it can be mixed with the ion depleted stream obtained from the extraction stage. In addition to displacing the sulfide species, reducing the concentration of sulfide species can include oxidizing the sulfide species using a chemical or biological agent that reacts with the sulfide species, withdrawing the sulfide species using withdrawal material in an adsorption-desorption process, such as a counter-current adsorption-desorption (CCAD) process, or any combination thereof. The sulfides can be chemically converted to a reagent that can be recycled in some cases. The reagent may be used, for example, to adjust pH of the extraction feed, a stream obtained from the extraction feed, or both. Additionally or alternately, the sulfides can be removed by gas sparging, membranes, adsorber media, chemical treatment, or any combination thereof.

As described above, direct aqueous extraction of ions can include an adsorption/desorption process that may be a counter-current adsorption/desorption. The direct extraction can use a selective withdrawal material configured to selectively withdraw one or more ions into the withdrawal material yield a loaded withdrawal material and an ion depleted stream. In such case, direct aqueous extraction also includes passing an eluent through the loaded withdrawal material to remove ions from the withdrawal material and yield the extract. In particular, the withdrawal material is selective to lithium. In an embodiment, the sulfide species is removed from the stream derived from the aqueous source and mixed with the ion depleted stream. Direct aqueous extraction of ions can, additionally or alternately, use an electrochemical separation process having a membrane selective for the target ion to yield the extract. The electrochemical separation may also yield a lithium depleted stream.

Methods herein may further include concentrating a stream derived from an extract, obtained from an ion extraction process described herein, in a concentration stage to yield a concentrate. Concentrating the extract may include membrane separation, evaporation, or any combination thereof. In one case, concentrating the extract includes membrane separation, and the membrane separation includes a reverse osmosis, a counter-flow reverse osmosis, or both to yield the concentrate and a diluted stream. In such embodiment, the method may further comprise recycling the diluted stream to the extraction stage. In an embodiment, the concentration stage produces a concentrate having total dissolved solids (TDS) over 120,000 mg/l.

The methods may further comprise routing the extract, a stream derived from the extract, or both, to an impurity removal stage to reduce concentration of one or more hardness species, one or more transition metals, one or more divalent impurities, or a combination thereof. The impurity removal stage may reduce concentration of calcium, magnesium, aluminum, manganese, iron, barium, boron, scale-forming salts, or any combination thereof.

In an embodiment, the aqueous source is a salar brine, a continental brine, an oilfield brine, a produced water, a geothermal brine, a seawater source, or a combination thereof. In particular, the aqueous source may be a Smackover brine. In an embodiment, the aqueous source may be a Bakken brine.

The methods described herein also include removing sulfide species, organic species, or both from an aqueous source comprising lithium ions and bromide ions; reacting a stream derived from the aqueous source with a chlorine gas stream to form bromine and a bromide depleted aqueous stream; extracting lithium ions from a stream derived from the bromide depleted using a direct extraction process to a lithium extract; and converting lithium of the lithium extract to lithium hydroxide in an electrochemical process that uses a lithium selective barrier to form the chlorine gas stream. The methods can further include converting at least a portion of the lithium hydroxide to lithium carbonate, removing water from at least a portion of the lithium hydroxide to form a solid lithium hydroxide product, or both.

The methods described herein can also include reducing a concentration of at least one or more of a sulfide species, organic species, and transition metal ions from an aqueous source to form a purified aqueous source; extracting lithium ions from a stream derived from the purified aqueous using a direct extraction process to form a lithium depleted stream comprising bromide ions and a lithium extract comprising lithium ions; converting lithium of the lithium extract to lithium hydroxide in an electrochemical process that uses a lithium selective barrier to form a chlorine gas stream; and reacting the lithium depleted stream with the chlorine gas stream to form bromine and a bromide depleted aqueous stream. The methods can also include converting at least a portion of the lithium hydroxide to lithium carbonate, removing water from at least a portion of the lithium hydroxide to form a solid lithium hydroxide product, or both.

The methods disclosed herein also include Reducing the concentration of one or more of sulfide species, organic species, and transition metal ions, from an aqueous source to form a purified aqueous source; extracting lithium ions from a stream derived from the purified aqueous using a direct extraction process to form a lithium depleted stream comprising bromide ions and a lithium extract comprising lithium ions; converting lithium of the lithium extract to lithium hydroxide in an electrochemical process that uses a lithium selective barrier to form a chlorine gas stream; and reacting the lithium depleted stream with the chlorine gas stream to form bromine and a bromide depleted aqueous stream.

While the foregoing is directed to embodiments of the present invention, other and further embodiments of the present disclosure may be devised without departing from the basic scope thereof, and the scope thereof is determined by the claims that follow.

1. A method, comprising:
generating chlorine gas in a conversion process that converts metal chloride from an aqueous medium obtained from a metal containing aqueous source into a hydroxide material;
recovering the chlorine gas; and
recovering bromine by reacting the chlorine gas with a bromide containing aqueous source.

2. The method of claim 1, wherein the conversion process is a lithium conversion process that converts lithium chloride to a lithium hydroxide material.

3. The method of claim 1, wherein the conversion process is an electrochemical process that uses an anode and a cathode, wherein chlorine gas is generated at the anode from chloride ions of the aqueous medium.

4. The method of claim 3, wherein the anode and the cathode are separated by a lithium selective barrier.

5. The method of claim 1, further comprising separating a target metal of an extraction feed derived from the metal containing aqueous source using a direct extraction process to form an extract, wherein the aqueous medium is derived from the extract and wherein the metal of the metal chloride is the target metal.

6. The method of claim 5, wherein the target metal is lithium.

7. The method of claim 5, further comprising concentrating a stream derived from the extract to form a concentrate, wherein the aqueous medium is derived from the concentrate.

8. The method of claim 5, wherein reacting the chlorine gas with the bromide containing aqueous source yields a bromine product and a bromide depleted stream, wherein the extraction feed is derived from the bromide depleted stream.

9. The method of claim 5, wherein the direct extraction process yields a target metal depleted stream, and wherein the target metal depleted stream is the bromide containing aqueous source.

10. The method of claim 1, further comprising one or more of:
reducing a concentration of sulfide species, or
reducing a concentration of organic species,
reducing a concentration of transition metal ions,
in a first stream, wherein the bromide containing aqueous source and/or the extraction feed is derived from the first stream.

11. The method of claim 10, wherein the sulfide species includes one or more of hydrogen sulfide (H2S), bisulfide (HS−), and/or sulfide (S2−) species.

12. The method of claim 8, wherein the bromide depleted stream includes sulfide species, wherein reacting the chlorine gas with the bromide depleted stream also yields a sulfur product, wherein the method includes removing the sulfur product from the bromide depleted stream.

13. A method, comprising:
withdrawing lithium ions from an aqueous medium comprising lithium ions using a direct extraction process to form an aqueous lithium extract;
converting lithium ions of a stream derived from the lithium extract to lithium hydroxide using an electrochemical process;
converting chloride ions of the stream derived from the lithium extract to chlorine gas using the electrochemical process; and
reacting the chlorine gas with an aqueous source comprising bromide ions to form bromine gas from the bromide ions.

14. The method of claim 13, wherein reacting the chlorine gas with the aqueous source forms a bromine depleted stream, wherein the aqueous medium is derived from the bromine depleted stream.

15. The method of claim 14, wherein the bromide depleted stream includes sulfide species, wherein reacting the chlorine gas with the bromide depleted stream also yields a sulfur product, wherein the method includes removing the sulfur product from the bromide depleted stream.

16. The method of claim 13, wherein the direct extraction process yields a lithium depleted stream, and the aqueous source comprising bromide ions is derived from the lithium depleted stream.

17. The method of claim 13, further comprising one or more of:
reducing a concentration of sulfide species, or
reducing a concentration of organic species,
reducing a concentration of transition metal ions,
in a first stream to form the aqueous medium and/or the aqueous source comprising bromide ions.

18. The method of claim 13, further comprising further comprising concentrating a stream derived from the extract to form a concentrate, wherein converting lithium and chloride ions of a stream derived from the lithium extract includes converting lithium and chloride ions of a stream derived from the concentrate.

19. A method, comprising:
reducing a concentration of at least one or more of sulfide species, transition metal ions, organic species, from an aqueous source comprising lithium ions and bromide ions;
reacting a stream derived from the aqueous source with a chlorine gas stream to form bromine and a bromide depleted aqueous stream;
extracting lithium ions from a stream derived from the bromide depleted using a direct extraction process to a lithium extract;
converting lithium of the lithium extract to lithium hydroxide in an electrochemical process that uses a lithium selective barrier to form the chlorine gas stream.

20. (canceled)
